(19) United States
(12) Patent Application Publication
(10) Pub. No.: US 2024/0375211 A1
(43) Pub. Date: Nov. 14, 2024

(54) LASER PROCESSING METHOD

(71) Applicant: Panasonic Intellectual Property Management Co., Ltd., Osaka (JP)

(72) Inventors: Tatsuyuki NAKAGAWA, Osaka (JP); Atsuhiro KAWAMOTO, Hyogo (JP); Junji FUJIWARA, Osaka (JP); Michio SAKURAI, Osaka (JP)

(21) Appl. No.: 18/781,168

(22) Filed: Jul. 23, 2024

Related U.S. Application Data
(63) Continuation of application No. PCT/JP2023/003155, filed on Feb. 1, 2023.

(30) Foreign Application Priority Data
Feb. 2, 2022 (JP) 2022-014615

(51) Int. Cl. B23K 26/06

(52) U.S. Cl. CPC B23K 26/0626

(57) ABSTRACT

A transmission fiber includes a first core and a second core. The second core is provided on the outer periphery of the first core. In a first step of a laser termination process, a first laser beam is emitted from the second core, and a second laser beam is emitted from the first core. In a second step, the output power of the second laser beam is gradually reduced while a position at which the first laser beam and the second laser beam are emitted to a workpiece is moved in a laser processing direction. In a third step, the output of the second laser beam is stopped while the first laser beam is emitted from the second core.

### CROSS-REFERENCE TO RELATED APPLICATION

This application claims priority to Japanese Patent Application No. 2022-014615 filed on Feb. 2, 2022, the entire disclosure of which is incorporated by reference herein.

### BACKGROUND

The present invention relates to a laser processing method.

German Patent Application Publication No. 102011078173 discloses a laser cutting method using a first laser beam and a second laser beam emitted to a workpiece. The first laser beam enters a first fiber core of a double-clad fiber, and the second laser beam with a wavelength different from that of the first laser beam enters a second fiber core.

### SUMMARY

In the known technique, craters may be formed when the emission of the first laser beam and the second laser beam are stopped at the same time at a laser end point. This may degrade the workpiece processing quality.

It is therefore an object of the present invention to reduce the formation of craters at a laser end point.

A first aspect is directed to a laser processing method for processing a workpiece by emitting laser beams transmitted through a transmission fiber, the transmission fiber at least including a first core and a second core provided on an outer periphery of the first core, the laser beams including a first laser beam and a second laser beam having a longer wavelength than a wavelength of the first laser beam, the method comprising: a laser termination process of adjusting output power of the first laser beam and output power of the second laser beam at an end of processing of the workpiece, the laser termination process including: a first step of emitting the first laser beam from the second core and emitting the second laser beam from the first core; a second step of gradually reducing the output power of the second laser beam emitted from the first core while moving in a laser processing direction a position at which the first laser beam and the second laser beam are emitted to the workpiece; and a third step of stopping outputting the second laser beam while the first laser beam is emitted from the second core.

According to the first aspect, the transmission fiber at least includes the first core and the second core. The second core is provided on the outer periphery of the first core. In the first step of the laser termination process, the first laser beam is emitted from the second core, and the second laser beam is emitted from the first core. In the second step, the output power of the second laser beam emitted from the first core is gradually reduced, while a position at which the first laser beam and the second laser beam are emitted to the workpiece is moved in the laser processing direction. In the third step, the output of the second laser beam is stopped while the first laser beam is emitted from the second core.

The ring-shaped first laser beam that has passed through the second core is emitted to surround the second laser beam emitted from the first core. It is thus possible to preheat a region in front of the second laser beam and also make the processed surface behind the second laser beam smooth.

To keep emitting the first laser beam even after the stop of the output of the second laser beam at the laser end point can reduce craters at the welding end point. It is thus possible to enhance the quality of processing the workpiece.

A second aspect is an embodiment of the first aspect. In the second aspect, the laser termination process includes, after the third step, a fourth step of emitting the first laser beam from the first core and the second core.

According to the second aspect, increasing the emission range of the first laser beam by emitting the first laser beam from the first core and the second core can reduce craters at the welding end point in a wider range.

According to the aspects of the present disclosure, it is possible to reduce the formation of craters at the laser end point.

### BRIEF DESCRIPTION OF THE DRAWINGS

FIG. 1 is a side view illustrating a general configuration of a laser processing apparatus according to an embodiment.

FIG. 2 is a cross-sectional view of a transmission fiber as viewed from the entrance end side.

FIG. 3 is a graph showing a relationship between the wavelength of a laser beam and reflectivity.

FIG. 4 is a graph showing changes of the total output power of laser beams over time.

FIG. 5A is a diagram illustrating a state in which a second laser beam enters a first core, and a first laser beam enters a second core.

FIG. 5B is a diagram illustrating a state in which the second laser beam is emitted from the first core and the first laser beam is emitted from the second core, during movement of a laser processing head.

FIG. 6A is a diagram illustrating a state in which output power of the second laser beam entering the first core is reduced.

FIG. 6B is a diagram illustrating a state in which output power of the second laser beam is reduced while moving a position at which the first laser beam and the second laser beam are emitted.

FIG. 7A is a diagram illustrating a state in which the first laser beam enters the second core.

FIG. 7B is a diagram illustrating a state in which the first laser beam is emitted from the second core at a laser end point.

FIG. 8A is a diagram illustrating a state in which the first laser beam enters the first core and the second core.

FIG. 8B is a diagram illustrating a state in which the first laser beam is emitted from the first core and the second core at the laser end point.

FIG. 9 is a graph showing changes of the total output power of laser beams over time according to a variation.

### DETAILED DESCRIPTION

An embodiment of the present invention will be described in detail with reference to the drawings. The following description of the embodiment is merely an example in nature, and is not intended to limit the scope, applications, or use of the present invention.

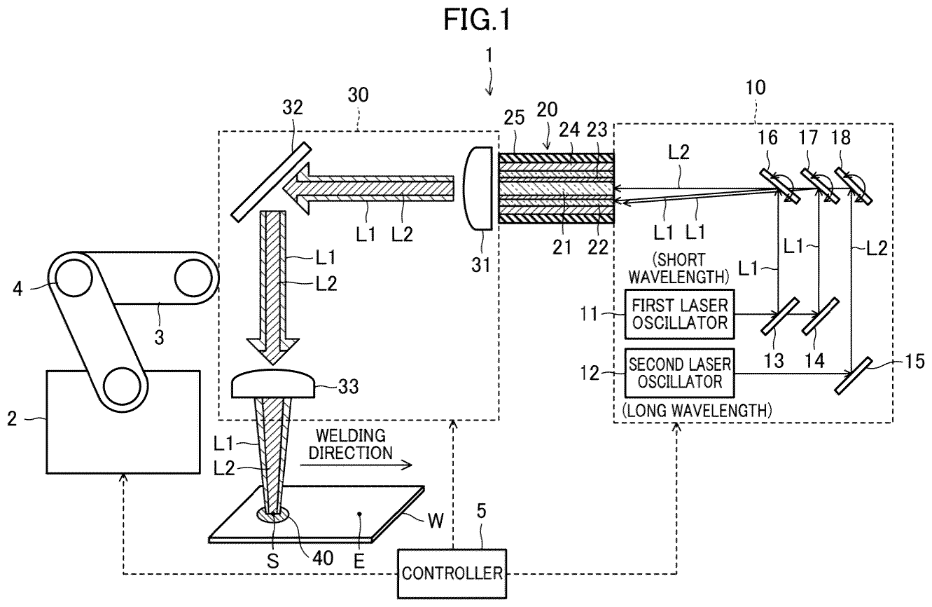

As illustrated in FIG. 1, a laser processing apparatus 1 includes an optical coupling unit 10, a transmission fiber 20, a laser processing head 30, a robot 2, and a controller 5. The optical coupling unit 10 includes a first laser oscillator 11, a second laser oscillator 12, a first mirror 13, a second mirror 14, a third mirror 15, a first adjustment mechanism 16, a second adjustment mechanism 17, and a third adjustment mechanism 18.

The first laser oscillator 11 emits a first laser beam L1 based on a command from the controller 5. The first laser beam L1 is a short-wavelength laser beam. The short-wavelength first laser beam L1 is a blue laser beam or a green laser beam with a wavelength of 600 nm or less (e.g., 266 nm to 600 nm). The first laser oscillator 11 emits a plurality of first laser beams L1 from a plurality of laser modules (not shown).

The second laser oscillator 12 emits a second laser beam L2 based on a command from the controller 5. The second laser beam L2 is a long-wavelength laser beam with a wavelength that is longer than that of the first laser beams L1. The long-wavelength second laser beam L2 is an infrared laser beam with a wavelength of 800 nm or more (e.g., about 800 nm to 16000 nm).

The first mirror 13 reflects part of the plurality of first laser beams L1 emitted from the first laser oscillator 11 to guide the first laser beam L1 to the first adjustment mechanism 16.

The second mirror 14 reflects the rest of the first laser beams L1 emitted from the first laser oscillator 11 to guide the first laser beam L1 to the second adjustment mechanism 17.

The third mirror 15 reflects the second laser beam L2 emitted from the second laser oscillator 12 to guide the second laser beam L2 to the third adjustment mechanism 18.

The first adjustment mechanism 16 is, for example, a two-axis micro electro mechanical systems (MEMS) mirror. The first adjustment mechanism 16 further reflects the first laser beam L1 reflected off the first mirror 13 to guide the first laser beam L1 to the transmission fiber 20. The mirror angle of the first adjustment mechanism 16 is changed, thereby changing the incident position of the first laser beam L1 on the transmission fiber 20. This enables selective incidence of the first laser beam L1 on a first core 21 or a second core 22 of the transmission fiber 20.

The second adjustment mechanism 17 is, for example, a two-axis MEMS mirror. The second adjustment mechanism 17 further reflects the first laser beam L1 reflected off the second mirror 14 to guide the first laser beam L1 to the transmission fiber 20. The mirror angle of the second adjustment mechanism 17 is changed, thereby changing the incident position of the first laser beam L1 on the transmission fiber 20. This enables selective incidence of the first laser beam L1 on the first core 21 or the second core 22 of the transmission fiber 20.

The third adjustment mechanism 18 is, for example, a two-axis MEMS mirror. The third adjustment mechanism 18 further reflects the second laser beam L2 reflected off the third mirror 15 to guide the second laser beam L2 to the transmission fiber 20. The mirror angle of the third adjustment mechanism 18 is changed, thereby changing the incident position of the second laser beam L2 on the transmission fiber 20. This enables selective incidence of the second laser beam L2 on the first core 21 or the second core 22 of the transmission fiber 20.

The first adjustment mechanism 16, the second adjustment mechanism 17, and the third adjustment mechanism 18 may be two-axis galvanometers (galvanometer mirrors) instead of the two-axis MEMS mirrors.

The optical coupling unit 10 and the laser processing head 30 are connected together through the transmission fiber 20. The first laser beams L1 and the second laser beam L2 are transmitted to the laser processing head 30 through the transmission fiber 20.

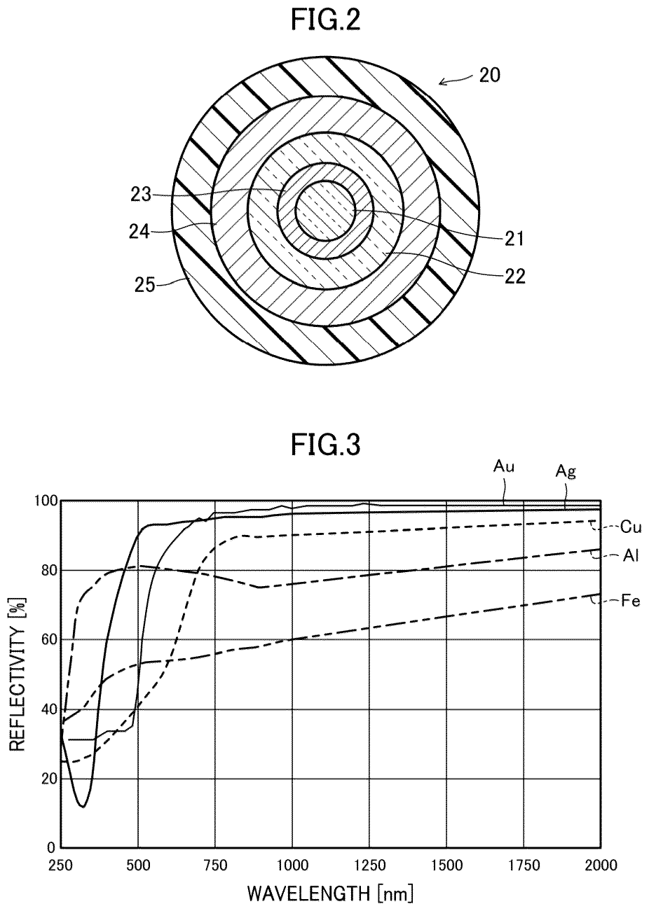

As illustrated also in FIG. 2, the transmission fiber 20 includes the first core 21, the second core 22, a first cladding 23, a second cladding 24, and a protective coating 25.

The first core 21 is arranged at the axis of the transmission fiber 20. The first core 21 has a circular shape as viewed in the axial direction. The first core 21 is made of, for example, silica glass.

The first cladding 23 is provided on the outer periphery of the first core 21. The first cladding 23 is coaxial with the first core 21. The first cladding 23 is made of a material having a lower refractive index than the first core 21. The first cladding 23 is made of, for example, silica glass doped with fluorine. The refractive index of the first cladding 23 is lower than the refractive index of the first core 21.

The second core 22 is provided on the outer periphery of the first cladding 23. The second core 22 is coaxial with the first core 21. The second core 22 has a ring shape as viewed in the axial direction. The second core 22 is made of the same material as the first core 21, such as silica glass. The refractive index of the second core 22 is higher than the refractive index of the first cladding 23.

The second cladding 24 is provided on the outer periphery of the second core 22. The second cladding 24 is coaxial with the first core 21 and the second core 22. The second cladding 24 is made of, for example, silica glass doped with fluorine. The refractive index of the second cladding 24 is lower than the refractive index of the second core 22.

The protective coating 25 is provided on the outer periphery of the second cladding 24. The protective coating 25 is made of, for example, a synthetic resin. The protective coating 25 mechanically protects the first core 21, the second core 22, the first cladding 23, and the second cladding 24, which are made of silica glass. The protective coating 25 reduces the first laser beams L1 and the second laser beam L2 leaking out of the transmission fiber 20 and reduces light leaking into the transmission fiber 20 from the outside.

As illustrated in FIG. 1, the laser processing head 30 emits the first laser beam L1 and the second laser beam L2 entering from the transmission fiber 20, to a workpiece W. In the example illustrated in FIG. 1, laser beams made of the circular second laser beam L2 and the ring-shaped first laser beam L1 surrounding the outer periphery of the second laser beam L2 are emitted.

The laser processing head 30 includes a collimating lens 31, a fourth mirror 32, and a condenser lens 33.

The collimating lens 31 collimates the first laser beam L1 and the second laser beam L2 emitted from the output end of the transmission fiber 20.

The fourth mirror 32 reflects the first laser beam L1 and the second laser beam L2 collimated by the collimating lens 31 to guide the beams to the condenser lens 33.

The condenser lens 33 condenses the first laser beam L1 and the second laser beam L2. The first laser beam L1 and the second laser beam L2 condensed by the condenser lens 33 are emitted to the workpiece W.

The robot 2 includes a robot arm 3. The laser processing head 30 is attached to the distal end of the robot arm 3. The robot arm 3 includes a plurality of joints 4.

The robot 2 moves the laser processing head 30 along a predetermined welding direction (processing direction) based on a command from the controller 5 and changes the position of the laser processing head 30 relative to the workpiece W. Laser processing is performed in this manner while moving the position at which the first laser beam L1 and the second laser beam L2 are emitted to the workpiece W.

The controller 5 is connected to the optical coupling unit 10, the laser processing head 30, and the robot 2. The controller 5 controls operations of the optical coupling unit 10, the laser processing head 30, and the robot 2.

The controller 5 has the function of controlling the moving speed of the laser processing head 30, and also the function of controlling, for example, the start and stop of the output of the first laser beam L1 and the second laser beam L2, and the output intensities of the first laser beam L1 and the second laser beam L2. Although the number of the controller 5 is one in this example, a plurality of controllers 5 may be provided.

The workpiece W has a plate-like shape, for example. The workpiece W is made of a high reflectivity material with a low laser absorptivity. Specifically, as shown in FIG. 3, the reflectivity of a laser beam varies depending on the material of the workpiece W. For example, if a long-wavelength infrared laser beam with a wavelength of 800 nm or more is used as a reference, copper (Cu), aluminum (Al), gold (Au), and silver (Ag) have the reflectivity (%) higher than that of iron (Fe) at the wavelength of the laser beam. In other words, they are high reflectivity materials with a low laser absorptivity. In contrast, the reflectivity (%) of iron (Fe) at the wavelength of the laser beam is relatively low. In other words, it is a low reflectivity material with a high laser absorptivity.

Thus, the workpiece W in this embodiment, which is a high reflectivity material with a low laser absorptivity, is made of copper. The workpiece W may be made of gold or silver.

### <Operation at Laser End Point>

The laser processing apparatus 1 emits the first laser beam L1 to melt a portion of the surface of the workpiece W first, and form a molten pool, at a laser starting point S, which is a welding start point of the workpiece W, at the start of laser irradiation in a laser irradiation start process, further preheats the portion, and then emits the second laser beam L2. It is therefore possible to reduce spatters at the laser starting point S in the laser irradiation start process.

The laser processing apparatus 1 emits the first laser beam L1 and/or the second laser beam L2 to the workpiece W to perform laser welding, while moving the laser processing head 30 from the laser starting point S to the laser end point E, which is the welding end point of the workpiece W.

Craters may be formed when the emission of the first laser beam L1 and the second laser beam L2 are stopped at the same time at the laser end point E of the workpiece W. This may degrade the quality of processing the workpiece W.

To address this problem, the laser processing apparatus 1 of this embodiment is controlled to reduce craters at the laser end point E in a laser termination process.

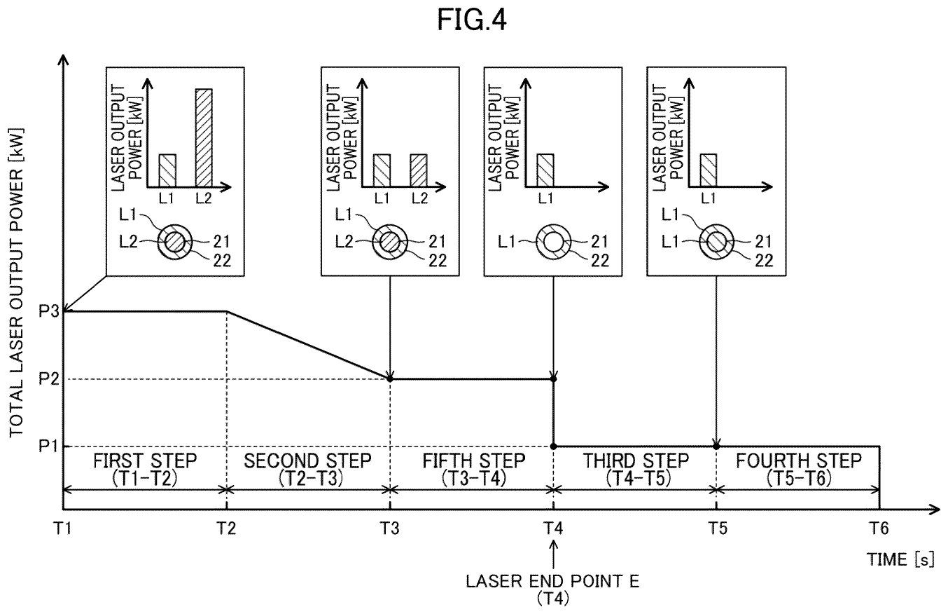

The laser termination process is specifically shown in FIG. 4. A main laser process transitions to the laser termination process at a predetermined time or a predetermined distance before the laser end point E, based on a laser termination command. In the laser termination process, the controller 5 performs a first step in a period between time T1 and time T2 which is after the laser processing head 30 has moved a predetermined distance from the laser starting point S in the welding direction. In the first step, the controller 5 controls an operation of the optical coupling unit 10 such that the first core 21 emits the long-wavelength second laser beam L2 and that the second core 22 emits the short-wavelength first laser beam L1. The controller 5 moves the laser processing head 30 in the welding direction.

The first step is to form, in a bead end region, a weld strength maintaining region for obtaining penetration that ensures joint strength. Accordingly, penetration is formed at the bead end with reliability. It is thus possible to prevent separation, which is a break starting from the bead end, even if stress is concentrated.

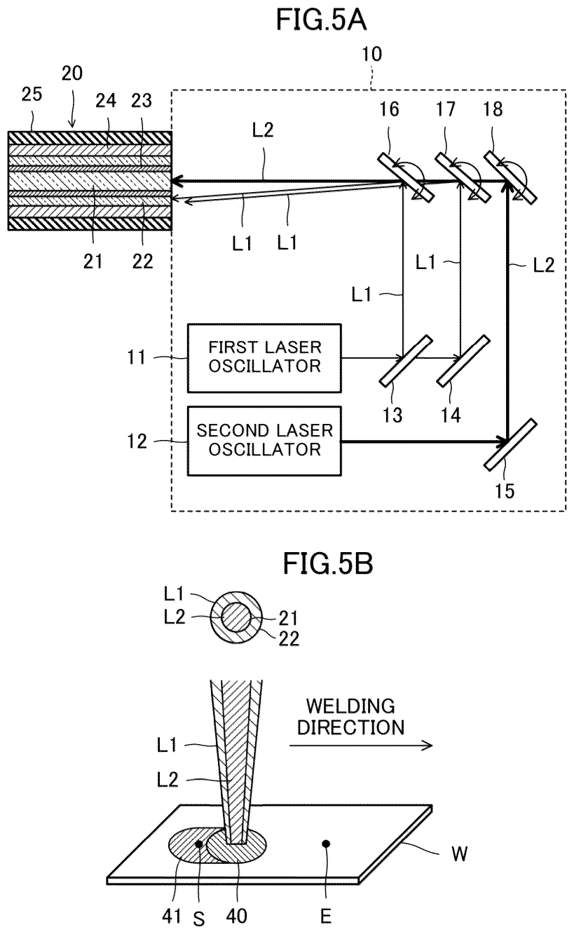

In the first step, as illustrated in FIG. 5A, the controller 5 causes the short-wavelength first laser oscillator 11 to emit the short-wavelength first laser beams L1, and causes the long-wavelength second laser oscillator 12 to emit the long-wavelength second laser beam L2.

The controller 5 adjusts the mirror angle of the first adjustment mechanism 16 to allow the first laser beam L1 reflected off the first mirror 13 to enter the second core 22 of the transmission fiber 20. The controller 5 adjusts the mirror angle of the second adjustment mechanism 17 to allow the first laser beam L1 reflected off the second mirror 14 to enter the second core 22 of the transmission fiber 20. The controller 5 adjusts the mirror angle of the third adjustment mechanism 18 to allow the second laser beam L2 reflected off the third mirror 15 to enter the first core 21 of the transmission fiber 20.

As illustrated in FIG. 5B, the long-wavelength second laser beam L2 that has entered the first core 21 is emitted in the shape of a circle to the workpiece W. The short-wavelength first laser beams L1 that have entered the second core 22 are emitted in the shape of a ring to the workpiece W. Here, the output power of the first laser beams L1 is set to be 0.5 kW to 4 kW, preferably 2 kW. The output power of the second laser beam L2 is set to be, for example, 10 kW.

The ring-shaped short-wavelength first laser beam L1 that has passed through the second core 22 is emitted to surround the long-wavelength second laser beam L2 emitted from the first core 21. It is thus possible to preheat a region in front of the second laser beam L2 and also make the processed surface behind the second laser beam L2 smooth.

The molten pool 40 is formed in the workpiece W at a position at which the short-wavelength first laser beam L1 and the long-wavelength second laser beam L2 are emitted to the workpiece W. Solidification of the molten pool 40 allows a weld bead 41 to be formed in a region of the workpiece W behind the molten pool 40 in the welding direction.

As shown in FIG. 4, the controller 5 performs a second step in a period between time T2 and time T3. In the second step, the controller 5 controls an operation of the optical coupling unit 10 such that the first core 21 emits the long-wavelength second laser beam L2 and that the second core 22 emits the short-wavelength first laser beam L1. Further, the controller 5 gradually reduces the output power of the long-wavelength second laser beam L2 emitted from the first core 21 while moving the laser processing head 30 in the welding direction.

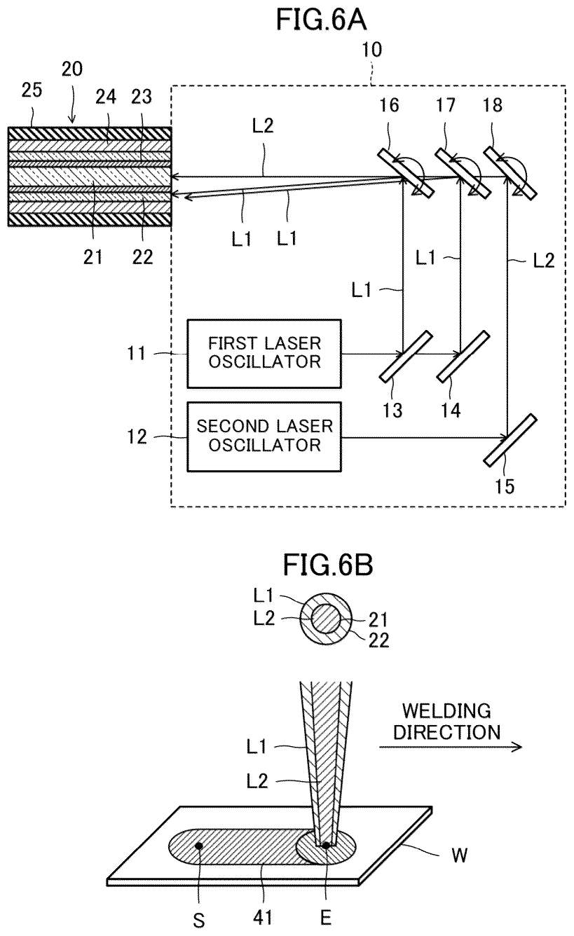

In the second step, as illustrated in FIG. 6A, the controller 5 causes the short-wavelength first laser oscillator 11 to emit the short-wavelength first laser beams L1, and causes the long-wavelength second laser oscillator 12 to emit the long-wavelength second laser beam L2.

The controller 5 adjusts the mirror angle of the first adjustment mechanism 16 to allow the first laser beam L1 reflected off the first mirror 13 to enter the second core 22 of the transmission fiber 20. The controller 5 adjusts the mirror angle of the second adjustment mechanism 17 to allow the first laser beam L1 reflected off the second mirror 14 to enter the second core 22 of the transmission fiber 20. The controller 5 adjusts the mirror angle of the third adjustment mechanism 18 to allow the second laser beam L2 reflected off the third mirror 15 to enter the first core 21 of the transmission fiber 20.

As illustrated in FIG. 6B, the long-wavelength second laser beam L2 that has entered the first core 21 is emitted in the shape of a circle to the workpiece W. The short-wavelength first laser beams L1 that have entered the second core 22 are emitted in the shape of a ring to the workpiece W. The controller 5 controls an operation of the second laser oscillator 12 to reduce the output power of the long-wavelength second laser beam L2 that has entered the first core 21. Here, the output power of the second laser beam L2 is set to be, for example, 4 kW.

Specifically, in the second step, the output power of the second laser beam L2 at time T3 is smaller than the output power of the second laser beam L2 at time T2 as shown in FIG. 4. Thus, the total output power P2 of the laser beams at time T3 is smaller than the total output power P3 of the laser beams at time T2. The controller 5 controls an operation of the second laser oscillator 12 so that the total output power of the laser beams gradually changes from P3 to P2 over a period from time T2 to time T3, in other words, so that the output power of the long-wavelength second laser beam L2 that has entered the first core 21 gradually decreases.

Gradually reducing the output power of the laser beam while moving the laser processing head 30 in the welding direction as described above can reduce spatters.

As shown in FIG. 4, the controller 5 performs a fifth step in a period between time T3 and time T4. In the fifth step, the controller 5 controls an operation of the optical coupling unit 10 such that the first core 21 emits the long-wavelength second laser beam L2 and that the second core 22 emits the short-wavelength first laser beam L1. The controller 5 moves the laser processing head 30 in the welding direction. The first laser beam L1 and the second laser beam L2 are emitted at the output power set as in FIGS. 6A and 6B in the period between time T3 and time T4.

As shown in FIG. 4, the controller 5 performs a third step in a period between time T4 and time T5. In the third step, the controller 5 controls an operation of the optical coupling unit 10 such that the output of the long-wavelength second laser beam L2 is stopped while the short-wavelength first laser beam L1 is emitted from the second core 22. The laser processing head 30 reaches the laser end point E at time T4. The controller 5 stops the movement of the laser processing head 30.

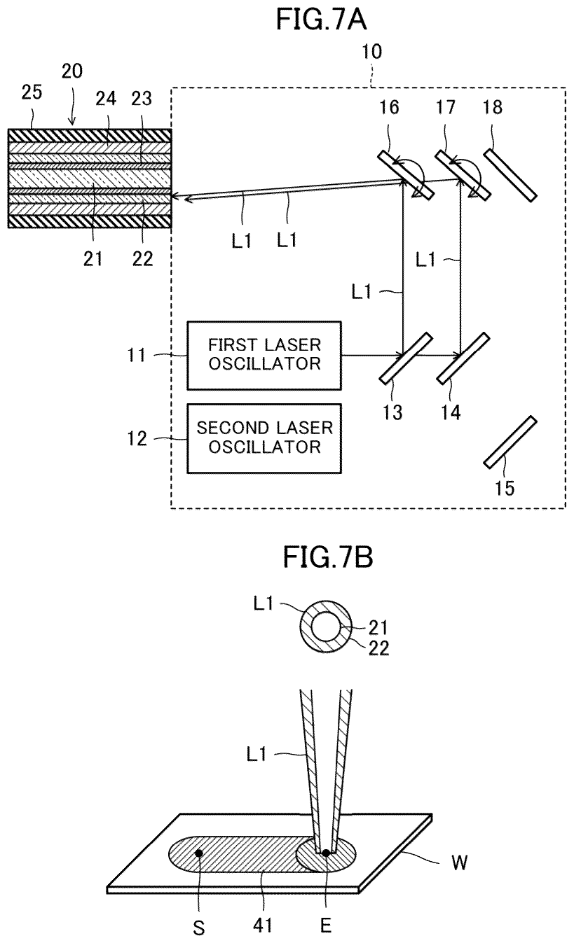

At the laser end point E (T4) at which the movement of the laser processing head 30 is stopped, the controller 5 causes the short-wavelength first laser oscillator 11 to emit the short-wavelength first laser beams L1 and stops the operation of the long-wavelength second laser oscillator 12, as illustrated in FIG. 7A. The controller 5 adjusts the mirror angle of the first adjustment mechanism 16 to allow the first laser beam L1 reflected off the first mirror 13 to enter the second core 22 of the transmission fiber 20. The controller 5 adjusts the mirror angle of the second adjustment mechanism 17 to allow the short-wavelength first laser beam L1 reflected off the second mirror 14 to enter the second core 22 of the transmission fiber 20. Thus, the total output power P1 of the laser beams at the laser end point E is smaller than the total output power P2 of the laser beams during the fifth step.

As illustrated in FIG. 7B, the short-wavelength first laser beams L1 that have entered the second core 22 are emitted in the shape of a ring to the workpiece W. The molten pool 40 is formed at the laser end point E of the workpiece W. To keep emitting the first laser beam L1 even after the stop of the output of the second laser beam L2 as described above can reduce craters at the laser end point E at which the movement of the laser processing head 30 is stopped. It is thus possible to enhance the quality of processing the workpiece W.

As shown in FIG. 4, the controller 5 performs a fourth step in a period between time T5 and time T6. In the fourth step, the controller 5 controls an operation of the optical coupling unit 10 such that both of the first core 21 and the second core 22 emit the short-wavelength first laser beams L1.

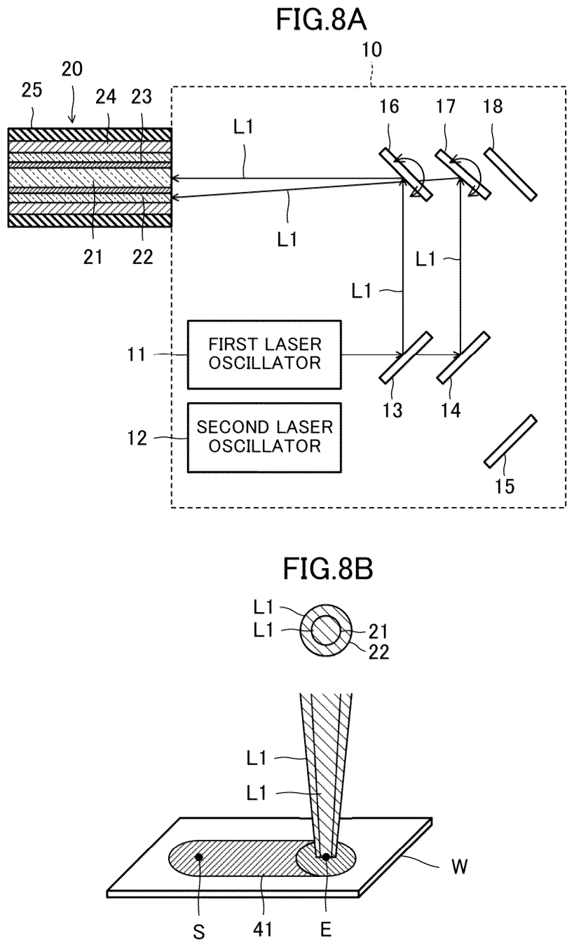

As illustrated in FIG. 8A, the controller 5 causes the first laser oscillator 11 to emit the short-wavelength first laser beams L1 and stops the operation of the long-wavelength second laser oscillator 12. The controller 5 adjusts the mirror angle of the first adjustment mechanism 16 to allow the first laser beam L1 reflected off the first mirror 13 to enter the first core 21 of the transmission fiber 20. Further, the controller 5 adjusts the mirror angle of the second adjustment mechanism 17 to allow the first laser beam L1 reflected off the second mirror 14 to enter the second core 22.

As illustrated in FIG. 8B, the short-wavelength first laser beam L1 that has entered the first core 21 is emitted in the shape of a circle to the workpiece W. The short-wavelength first laser beams L1 that have entered the second core 22 are emitted in the shape of a ring to the workpiece W. The short-wavelength first laser beams L1 emitted from the first core 21 and the second core 22 are combined together, so that the emission range of the first laser beams L1 to the workpiece W made of a highly reflective material becomes wider than the emission range (see FIG. 7B) of the first laser beam L1 in the third step.

Increasing the emission range of the first laser beam L1 without changing, or increasing, the output power by emitting the first laser beams L1 from the first core 21 and the second core 22 as described above can reduce craters at the laser end point E of the workpiece W made of a highly reflective material in a wider range.

As shown in FIG. 4, the controller 5 stops the operations of the first laser oscillator 11 and the second laser oscillator 12 and terminates laser welding at time T6.

### Variation

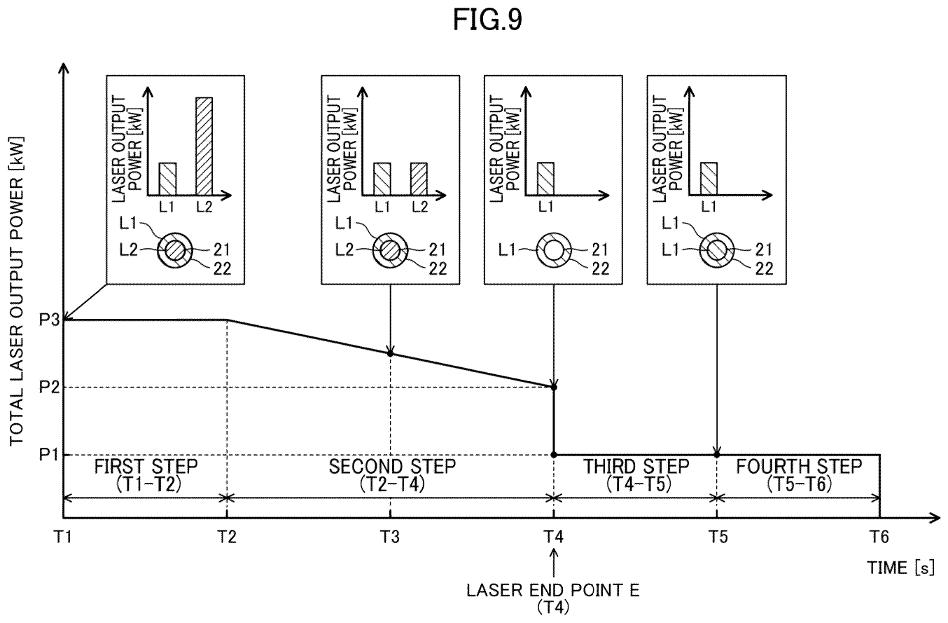

As illustrated in FIG. 9, a first step is performed in a period between time T1 and time T2, in which the second core 22 emits the short-wavelength first laser beam L1, and the first core 21 emits the second laser beam L2. In the first step, the total output power of the laser beams is P3.

A second step is performed in a period between time T2 and time T4, in which the output power of the second laser beam L2 emitted from the first core 21 is gradually reduced until the total output power of the laser beams changes from P3 to P2, while moving, in the laser processing direction, the position at which the short-wavelength first laser beam L1 and the long-wavelength second laser beam L2 are emitted to the workpiece W. At time T3, the output power of the first laser beam L1 and the output power of the second laser beam L2 are substantially the same.

A third step is performed in a period between time T4 and time T5, in which the output of the long-wavelength second laser beam L2 is stopped while the short-wavelength first laser beam L1 is emitted from the second core 22. In the third step, the total output power of the laser beams is P1. At time T4, which is the laser end point E, the movement of the laser processing head 30 is stopped, and the laser beam outputting is changed so that the output of the long-wavelength second laser beam L2 is stopped while the short-wavelength first laser beam L1 is emitted from the second core 22.

A fourth step is performed in a period between time T5 and time T6, in which the short-wavelength first laser beams L1 are emitted from the first core 21 and the second core 22.

### OTHER EMBODIMENTS

The embodiment described above may be modified as follows.

In the above embodiment, the robot 2 moves the laser processing head 30 to change the position of the laser processing head 30 relative to the workpiece W, but this is merely an example. For example, the workpiece W mounted on a movable table (not shown) may be moved relative to the laser processing head 30.

Alternatively, the laser processing head 30 and the movable table on which the workpiece W is mounted may be moved relative to each other, causing the first laser beams L1 and the second laser beam L2 to move relative to the workpiece W to process the workpiece W.

In the description of this embodiment, the short-wavelength first laser beam L1 and the long-wavelength second laser beam L2 are emitted from the single laser processing head 30, but this is merely an example. For example, a laser processing head that emits the short-wavelength first laser beam L1 and a laser processing head that emits the long-wavelength second laser beam L2 may be separate.

As can be seen from the foregoing description, the present invention can produce a highly practical effect of reducing craters at a laser end point, and is therefore very useful and has high industrial applicability.

What is claimed is:

1. A laser processing method for processing a workpiece by emitting laser beams transmitted through a transmission fiber,
the transmission fiber at least including a first core and a second core provided on an outer periphery of the first core,
the laser beams including a first laser beam and a second laser beam having a longer wavelength than a wavelength of the first laser beam,
the method comprising: a laser termination process of adjusting output power of the first laser beam and output power of the second laser beam at an end of processing of the workpiece,
the laser termination process including:
a first step of emitting the first laser beam from the second core and emitting the second laser beam from the first core;
a second step of gradually reducing the output power of the second laser beam emitted from the first core while moving in a laser processing direction a position at which the first laser beam and the second laser beam are emitted to the workpiece; and
a third step of stopping outputting the second laser beam while the first laser beam is emitted from the second core.

2. The laser processing method of claim 1, wherein
the laser termination process includes, after the third step, a fourth step of emitting the first laser beam from the first core and the second core.
